(19) United States
(12) Patent Application Publication
(10) Pub. No.: US 2005/0183053 A1
(43) Pub. Date: Aug. 18, 2005

(54) Software product for and method of laying-out semiconductor device

(75) Inventor: Michi Ishizuka, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION

(21) Appl. No.: 11/059,481

(22) Filed: Feb. 17, 2005

(30) Foreign Application Priority Data
Feb. 17, 2004 (JP) 039299/2004

(51) Int. Cl. G06F 17/50

(52) U.S. Cl. 716/10; 716/5; 716/12

(57) ABSTRACT

A software product for laying-out a semiconductor device includes the functions of: (A) locating a plurality of macros including a plurality of first macros of the same kind belonging to a first hierarchy; (B) arranging interconnections connecting between the plurality of macros; (C) extracting from the interconnections a plurality of overlapping sections which overlap with the plurality of first macros, respectively; (D) incorporating respective of the overlapping sections into the first macros; (E) calculating a forbidden area associated with any overlapping section by superposing the plurality of overlapping sections with reference to orientations of the first macros; and (F) arranging interconnections/components belonging to a lower hierarchy within each first macro such that the interconnections/components are not provided in the forbidden area.

### BACKGROUND OF THE INVENTION

1. Field of the Invention

The present invention relates to a software product for and a method of laying-out (designing) a semiconductor device. More particularly, the present invention relates to a software product for and a method of laying-out a semiconductor device by using a hierarchical design method.

2. Description of the Related Art In recent years, in the field of a semiconductor device such as a system LSI and an ASIC, the increase in required functions and performances makes the circuit configuration more complex. A hierarchical design method is often employed to design a semiconductor device. According to the hierarchical design method, a semiconductor device is treated as a set of function blocks (modules), and each of the function blocks is treated as a set of small-scale modules. Thus, a hierarchy structure is established. In the top hierarchy according to the hierarchical design, mega macros (large-scale function blocks) such as a CPU core and a DSP core are arranged, and then interconnections which connect between the arranged mega macros are provided. Interconnections and components within the mega macros correspond to the second hierarchy. A “macro” may be referred to as a “hierarchy macro” hereinafter.

FIGS. 1A and 1B are schematic diagrams showing a layout in the top hierarchy. As shown in FIG. 1A, three hierarchy macros 201, 202 and 203 and an interconnection 210 are arranged in the top hierarchy. The interconnection 210 is provided to connect between the hierarchy macro 201 and the hierarchy macro 203. In the layout of the top hierarchy, the interconnection 210 is allowed to pass over the hierarchy macro 202 located between the macros 201 and 203 in order to optimize the interconnection path. In some cases, a timing-adjustment component such as a repeater may be inserted into an interconnection of the top hierarchy for adjusting a signal timing. Such a timing-adjustment component is also allowed to be located on a hierarchy macro.

In the case that an interconnection which is not connected with a certain macro passes over the certain macro as mentioned above, an “incorporating (embedding) process” is carried out in which an overlapping section of the interconnection is incorporated (embedded) into the certain macro. More specifically, an information regarding the overlapping section is added to a netlist which describes the connectivity between components within the certain macro. Such an information does not exist originally in the netlist of the macro at the step of logic design.

For example, the above-mentioned interconnection 210 can be divided into an interconnection 211, an interconnection 212 and an interconnection 213 as shown in FIG. 1B. The interconnection 211 is located between the macro 201 and the macro 202, and the interconnection 213 is located between the macro 202 and the macro 203. The interconnection 212 corresponds to the overlapping section of the interconnection 210 and is referred to as an “overpassing interconnection”. The overpassing interconnection 212 is dropped from the top hierarchy to a lower hierarchy, and is incorporated into the hierarchy macro 202.

Japanese Laid Open Patent Application (JP-P2000-100949A) and Japanese Laid Open Patent Application (JP-P2000-156414A) disclose such a conventional incorporating process in which an overpassing interconnection in the top hierarchy is dropped to the lower hierarchy.

Also, FIG. 2A shows another layout in the top hierarchy. As shown in FIG. 2A, hierarchy macros 204a, 204b, 204c and 204d and interconnections are arranged in the top hierarchy. In this example, the hierarchy macros 204a to 204d are the same macro and have the same functions. Here, the orientations of the hierarchy macros 204a to 204d are different from each other. A hierarchy macro stored in a macro library is copied and arranged in the top hierarchy after inverted and rotated. In the example shown in FIG. 2A, the orientation of the hierarchy macro 204a is defined as an N-orientation. In this case, the hierarchy macro 204b is inverted left-to-right with respect to the N-orientation. The hierarchy macro 204c is inverted top-to-bottom with respect to the N-orientation. The hierarchy macro 204d is inverted left-to-right and top-to-bottom with respect to the N-orientation.

Also, as shown in FIG. 2A, timing-adjustment components such as repeaters are inserted to predetermined positions of the interconnections in the top hierarchy in order to adjust a signal timing. An overlapping section is defined as a section of the interconnections and repeaters which overlaps with any of the macros 204a to 204d. When the interconnections and the repeaters are arranged in the top hierarchy as shown in FIG. 2A, positions of the overlapping sections to be incorporated into respective of the macros 204a to 204d are different from each other, although the hierarchy macros 204a to 204d have the same functions. Therefore, at the time of the incorporating process and laying-out of the second hierarchy (interior of each macro), the hierarchy macros 204a to 204d mentioned above are recognized as different hierarchy macros 204 to 207, respectively, as shown in FIG. 2B. The layouts of the second hierarchy are carried out independently for respective of the hierarchy macros 204 to 207.

According to the conventional layout method as described above, the hierarchy macros 204 to 207 are treated as four different macros at the time of the incorporating process, even though they are the same hierarchy macros having the same function. In this case, although only one kind of hierarchy macro in the macro library is used, four kinds of hierarchy macros must be processed in laying-out the semiconductor device. Thus, the number of steps for designing increases as the number of hierarchy macros used increases. Also, the operation and the layout of the designed semiconductor device are checked (verified) after the layout process. Such a verification should be also carried out for each of the four kinds of the hierarchy macros. As a result, the TAT (Turn Around Time) in the design process of the semiconductor device increases.

### SUMMARY OF THE INVENTION

It is therefore an object of the present invention to provide a software product and a method for laying-out a semiconductor device which can reduce the time necessary for the layout process.

Another object of the present invention is to provide a software product and a method for laying-out a semiconductor device which can reduce the TAT (Turn Around Time) in the layout process.

In an aspect of the present invention, a software product for laying-out a semiconductor device by using a hierarchical design method is stored in a recording medium and is executed by a computer. The software product includes the functions of: (A) locating a plurality of macros belonging to a first hierarchy, the plurality of macros including a plurality of first macros having the same function; (B) arranging a connection structure connecting between the plurality of macros; (C) extracting from the connection structure a plurality of overlapping sections which overlap with the plurality of first macros, respectively; (D) incorporating respective of the plurality of overlapping sections into the plurality of first macros, interiors of the plurality of first macros being associated with a second hierarchy lower than the first hierarchy; (E) calculating a forbidden area associated with any of the plurality of overlapping sections by superposing the plurality of overlapping sections with reference to orientations of respective of the plurality of first macros; and (F) arranging interconnections and components belonging to the second hierarchy within each of the plurality of first macros such that the interconnections and the components are not provided in the forbidden area.

The connection structure mentioned above includes a group of interconnections connecting between the plurality of macros. The connection structure can further includes a component for adjusting a signal timing which is inserted into the group of interconnections.

According to the software product, the forbidden area is calculated after the orientations are aligned with each other in the above-mentioned (E) calculating.

The software product further includes the function of (G) generating a layout data by integrating the plurality of macros belonging to the first hierarchy, a non-overlapping section of the connection structure which does not overlap with the plurality of first macros, the plurality of overlapping sections and the interconnections and the components belonging to the second hierarchy.

In another aspect of the present invention, a method of laying-out a semiconductor device by using a computer includes (a) locating a plurality of macros belonging to a first hierarchy, the plurality of macros including a plurality of first macros having the same function; (b) arranging a connection structure connecting between the plurality of macros; (c) extracting from the connection structure a plurality of overlapping sections which overlap with the plurality of first macros, respectively; (d) incorporating respective of the plurality of overlapping sections into the plurality of first macros, interiors of the plurality of first macros being associated with a second hierarchy lower than the first hierarchy; (e) calculating a forbidden area associated with any of the plurality of overlapping sections by superposing the plurality of overlapping sections with reference to orientations of respective of the plurality of first macros; (f) arranging interconnections and components belonging to the second hierarchy within each of the plurality of first macros such that the interconnections and the components are not provided in the forbidden area; and (g) generating a layout data by integrating the plurality of macros belonging to the first hierarchy, a non-overlapping section of the connection structure which does not overlap with the plurality of first macros, the plurality of overlapping sections and the interconnections and the components belonging to the second hierarchy, and storing the layout data in a storage unit.

The connection structure includes a group of interconnections connecting between the plurality of macros. The connection structure further includes a component for adjusting a signal timing which is inserted into the group of interconnections.

According to the method, the forbidden area is calculated after the orientations are aligned with each other in the above-mentioned (e) calculating.

According to a software product and a method for designing a semiconductor device of the present invention, the overlapping sections of the connection structures (interconnections, timing-adjustment components) to be incorporated to the macros in the lower hierarchy are superposed (merged) for each kind of macro. Then, the layout in each of the macros (the second hierarchy) is carried out. Thus, it is enough to execute the layout only one time for the macros of the same kind. Therefore, it is possible to reduce the number of steps for laying-out (designing) a semiconductor device, and hence to reduce the time necessary for the layout process and the TAT in the layout process.

### BRIEF DESCRIPTION OF THE DRAWINGS

FIG. 1A is a schematic diagram showing a layout in the top hierarchy according to the conventional technique;

FIG. 1B is a schematic diagram showing an incorporating process according to the conventional technique;

FIG. 2A is a schematic diagram showing another layout in the top hierarchy according to the conventional technique;

FIG. 2B is a schematic diagram showing an incorporating process according to the conventional technique;

FIG. 3 is a flowchart showing a procedure of a method of laying-out a semiconductor device according to the present invention;

FIG. 4 is a schematic diagram showing a layout in the top hierarchy according to the present invention;

FIG. 5 is a schematic diagram showing a top hierarchy floor plan data after incorporating process according to the present invention;

FIG. 6 is a schematic diagram showing overlapping sections (overpassing interconnections) incorporated into macros 101a to 101d according to the present invention;

FIG. 7 is a schematic diagram showing a forbidden area according to the present invention; and

FIG. 8 is a schematic diagram showing a generation of an intra-macro final layout data according to the present invention.

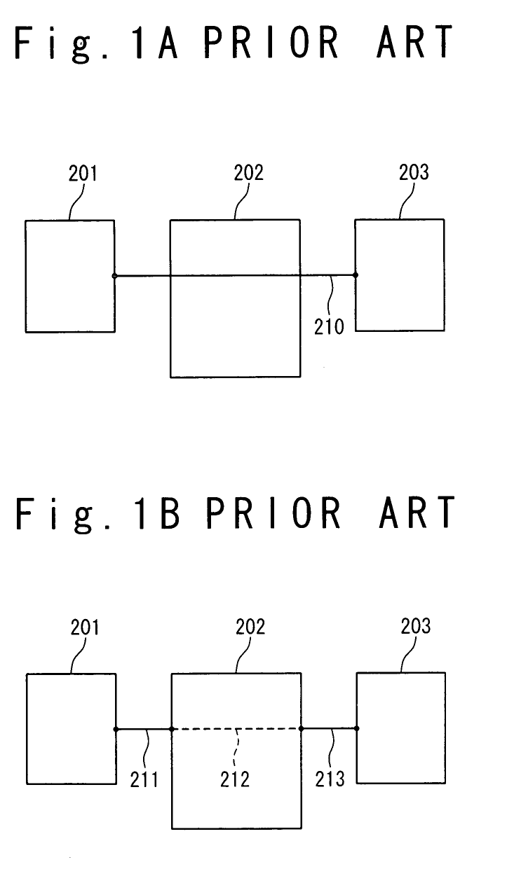

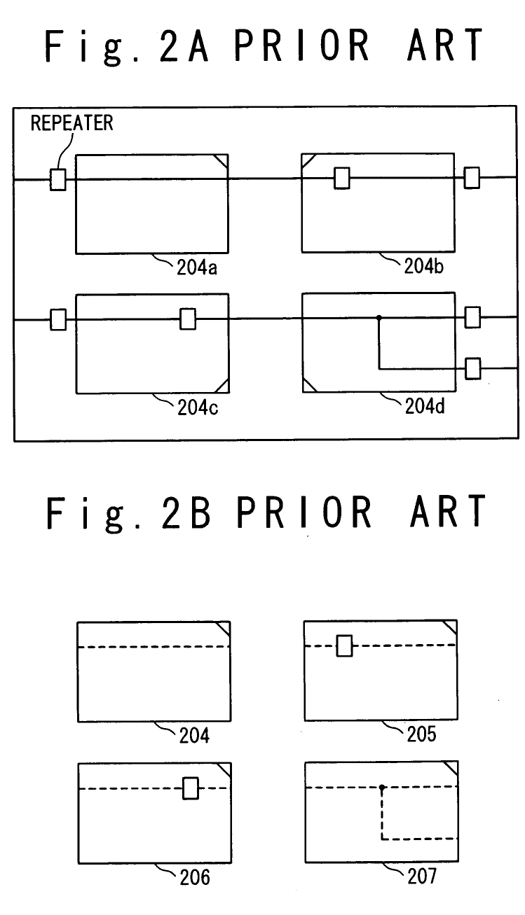

### DESCRIPTION OF THE PREFERRED EMBODIMENTS

Embodiments of the present invention will be described below with reference to the attached drawings.

According to the present invention, laying-out (designing) of a semiconductor device is carried out by using a computer system, i.e., a CAD (Computer Aided Design) system. The computer system has a storage unit, a processing unit accessible to the storage unit, and a computer program (software product) executed by the processing unit. The software product can be stored in a recording medium. To implement a method of laying-out according to the present, the software product has computer readable codes configured to cause the computer (processing unit) to operate as described below. In other words, the software product has functions as described below.

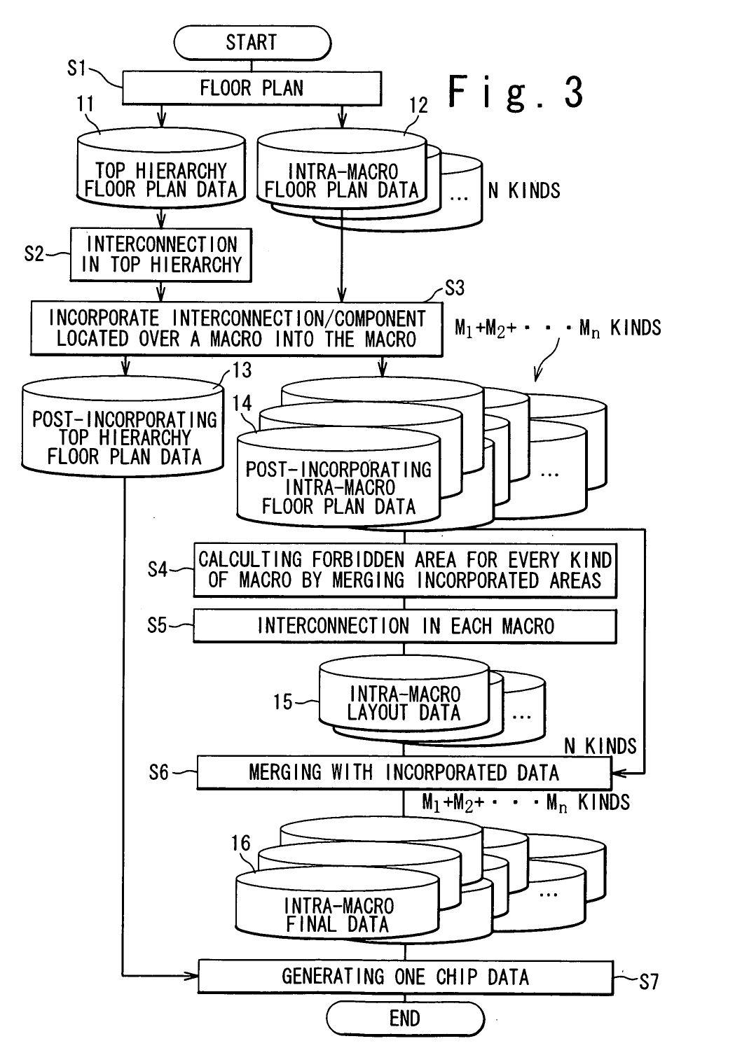

FIG. 3 is a flowchart showing a procedure of a method of laying-out a semiconductor device according to the present invention. First, a layout hierarchy is determined, and a netlist is divided based on the hierarchy structure. Next, a floor plan in each hierarchy is created (Step S1). For example, a plurality of hierarchy macros belonging to the top hierarchy are located. More specifically, a shape, a size, a position and an orientation of each macro (hierarchy macro) in each hierarchy are determined. As a result, for example, a top hierarchy floor plan data 11 and intra-macro floor plan data 12 are generated as shown in FIG. 3. The top hierarchy floor plan data 11 includes a floor plan of the top hierarchy (first hierarchy). Each of the intra-macro floor plan data 12 includes a floor plan within each hierarchy macro (second hierarchy). The second hierarchy is lower than the first hierarchy.

The top hierarchy floor plan data 11 and the intra-macro floor plan data 12 which are generated at the Step S1 are stored in the storage unit. When there are N (N is a natural number) kinds of hierarchy macros to be arranged on the top hierarchy, N kinds of intra-macro floor plan data 12 are generated in the Step S1, as shown in FIG. 3. A plurality of hierarchy macros of the same kind, in other words, a plurality of hierarchy macros having the same function may be arranged on the top hierarchy. The plurality of hierarchy macros of the same kind may be arranged with different orientations due to inversion and rotation.

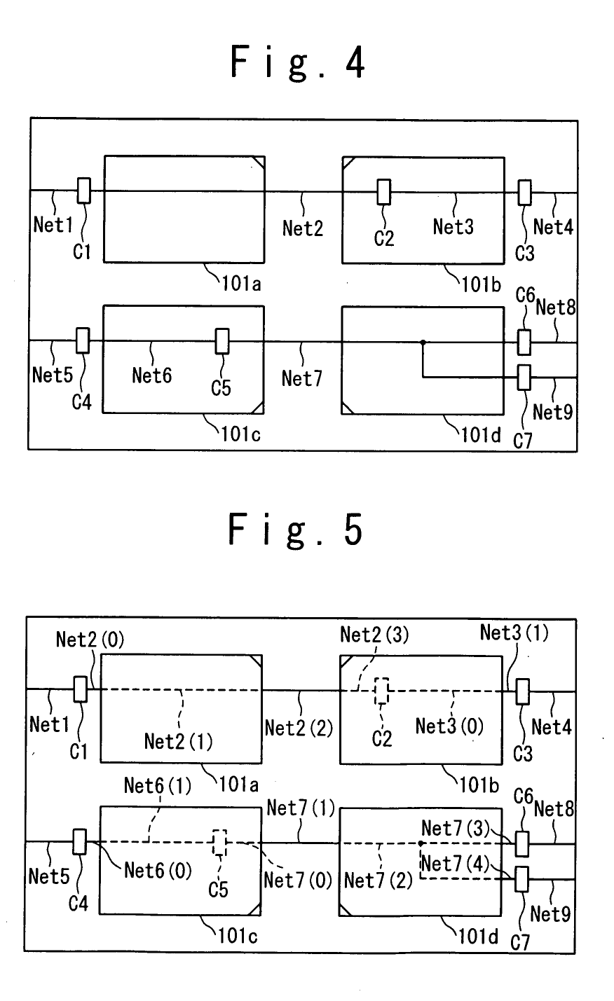

FIG. 4 is a schematic diagram showing an example of the layout in the top hierarchy according to the present invention. As shown in FIG. 4, hierarchy macros 101a to 101d belonging to the top hierarchy are located. The hierarchy macros 101a to 101d (first macros) are hierarchy macros of the same kind and have the same function. In the example shown in FIG. 4, the orientation of the first macro 101a is defined as an N-orientation. In this case, the first macro 101b is inverted left-to-right with respect to the N-orientation. The first macro 101c is inverted top-to-bottom with respect to the N-orientation. The first macro 101d is inverted left-to-right and top-to-bottom with respect to the N-orientation.

After the top hierarchy floor plan data 11 is generated, “connection structures” which connect between the plurality of hierarchy macros are arranged in the top hierarchy (Step S2). The connection structures includes a group of interconnections and timing-adjustment components such as repeaters. The interconnections connect between the plurality of hierarchy macros. The timing-adjustment components are provided in order to adjust a signal timing and are inserted into desirable positions of the interconnections. In FIG. 4, for example, interconnections Net1 to Net9 and repeaters (components) C1 to C7 are arranged on the top hierarchy.

In the layout of the top hierarchy, the interconnections are allowed to pass over a hierarchy macro in order to optimize the interconnection path. The repeaters are also allowed to be located over a hierarchy macro. For example, the interconnection Net2 overlaps with the first macros 101a and 101b as shown in FIG. 4. Similarly, the interconnection Net3 overlaps with the first macro 101b, the interconnection Net6 overlaps with the first macro 101c, and the interconnection Net7 overlaps with the first macros 101c and 101d. Also, the repeaters C2 and C5 are formed over the first macros 101b and 101c, respectively. An “overlapping section” is defined as a section of the connection structure (interconnections and repeaters) which overlaps with any of the first macros 101a to 101d.

As shown in FIG. 5, the interconnection Net2 can be divided into sections Net2(0), Net2(1), Net2(2) and Net2(3). The interconnection Net3 can be divided into sections Net3(0) and Net3(1). The interconnection Net6 can be divided into sections Net6(0) and Net6(1). The interconnection Net7 can be divided into sections Net7(0), Net7(1), Net7(2), Net7(3) and Net7(4). Each of the sections Net2(1), Net2(3), Net3(0), Net6(1), Net7(0) and Net7(2) corresponds to the “overlapping section”. Also, each of the repeaters C2 and C5 corresponds to the “overlapping section”.

After the above-mentioned interconnection process in the top hierarchy (Step S2), the computer extracts a plurality of overlapping sections from the connection structure. Then, the computer carries out an “incorporating (embedding) process” in which each of the plurality of overlapping sections is incorporated (embedded) into corresponding one of the hierarchy macro (Step S3). It should be noted that the interior of each hierarchy macro is associated with the second hierarchy. Due to the incorporating process, a post-incorporating top hierarchy floor plan data 13 and a post-incorporating intra-macro floor plan data 14 are generated and stored in the storage unit. The positions of the overlapping sections in the hierarchy macros are different from each other. Thus, when the numbers of respective of the N kinds of hierarchy macros arranged on the top hierarchy are M₁, M₂ to M_{N}, (M₁+M₂+. . . M_{N}) kinds of post-incorporating intra-macro floor plan data 14 are generated in the Step S3.

In the post-incorporating top hierarchy floor plan data 13, as shown in FIG. 5, the overlapping sections which include the interconnections Net2(1), Net2(3), Net3(0), Net6(1), Net7(0), and Net7(2), and the repeaters C2 and C5 over the first macros 101a to 101d are removed. After the incorporating process, the interconnections Net1, Net4, Net5, Net8, Net9, Net2(0), Net2(2), Net3(1), Net6(0), Net7(1), Net7(3) and Net7(4), and the repeaters C1, C3, C4, C6 and C7 remain on the top hierarchy.

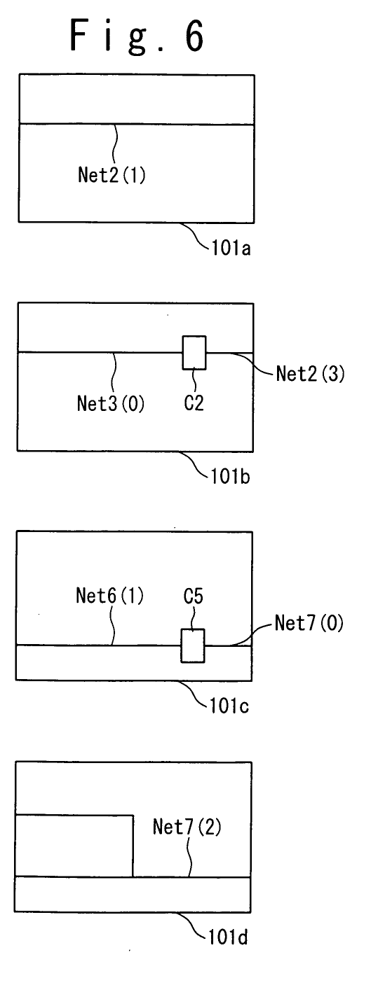

Also, FIG. 6 schematically shows the overlapping sections incorporated into the macros 101a to 101d. In FIG. 6, the orientations of the respective first macros 101a to 101d are aligned to the same direction (the N-orientation) with each other, although the first macros 101b to 101d are shown inverted or rotated with respect to the N-orientation in FIG. 4. As shown in FIG. 6, the positions of the incorporated (embedded) overlapping sections in the first macros 101a to 101d are different from each other. Thus, due to the incorporating process, four different post-incorporating intra-macro floor plan data 14 are generated from a same intra-macro floor plan data 12.

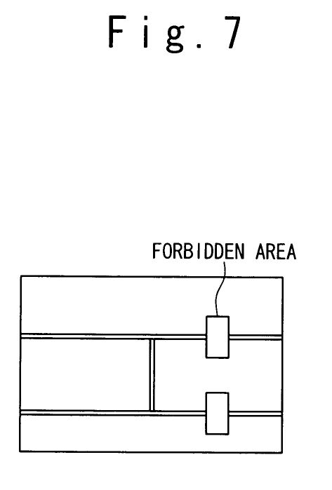

Next, the computer reads the post-incorporating intra-macro floor plan data 14 from the storage unit, and extracts information with regard to the positions of the overlapping sections in all the hierarchy macros. Then, the plurality of overlapping sections are superposed (merged) for each of the N kinds of the hierarchy macros (Step S4). For example, in the case of the first macros 101a to 101d, the positions of the incorporated overlapping sections Net2(1), Net2(3), Net3(0), Net6(1), Net7(0), Net7(2), C2 and C5 are superposed. The four post-incorporating intra-macro floor plan data 14 are merged to generate one merged data. Here, the superposing process (merging process) is carried out by referring to the orientations of respective of the plurality of first macros 101a to 101d. More specifically, the positions of the incorporated overlapping sections are superposed after the orientations of the respective first macros 101a to 101d are aligned with each other as shown in FIG. 6. As a result, a merged area is calculated and obtained as shown in FIG. 7.

The merged area is referred to as a “forbidden area”. The forbidden area shown in FIG. 7 is associated with any of the overlapping sections. The forbidden area is an area in which arrangement of interconnections and components belonging to the second hierarchy, which will be described later, is prohibited. More specifically, for example, the area corresponding to the incorporated interconnections is converted into an interconnection inhibition region, and the areas corresponding to the incorporated repeaters are converted into FILL cells which are arranged such that no other components are arranged therein. The computer calculates the forbidden area, and stores data indicative of the forbidden area in the storage unit.

Next, an interconnection (layout) process is carried out by the computer for each of the interiors of the hierarchy macros (Step S5). For example, interconnections and components belonging to the second hierarchy are arranged within each of the plurality of first macros. Here, the interconnection process is carried out such that the interconnections and the components within each first macro are not provided in the above-mentioned forbidden area. The interconnection process is carried out for each of the N kinds of hierarchy macros. As a result, N kinds of intra-macro layout data 15 are generated in the Step S5. Each of the intra-macro layout data 15 indicates a layout within the corresponding hierarchy macro, and is stored in the storage unit.

An operation verification is performed on each hierarchy macro on the basis of the intra-macro layout data 15 generated at the step S5. The operation verification includes, for example, a verification for checking whether or not a circuit operates at an expected timing based on a simulation or a static timing analysis, a verification for checking that a netlist after the layout process is consistent with a netlist prior to the layout process by using a style verification tool, a verification of an electric power consumption and the like. If the operation verification results in “Fail”, the layout process at the Step S5 is repeatedly performed until the fail is removed the result of the verification.

After the operation verification, a layout verification is performed for each hierarchy macro. At the time of the layout verification, a model of the hierarchy macro used for the operation verification of the top hierarchy is prepared. After the completion of the layout verification of the hierarchy macro, an operation verification of the top hierarchy is carried out by using the prepared model of the hierarchy macro. When it is confirmed that there is no fail in the result of the operation verification of the top hierarchy, the computer removes the information regarding the forbidden area from the intra-macro layout data 15. Then, the computer merges (integrates) the intra-macro layout data 15 from which the information regarding the forbidden area is removed and incorporated data regarding the incorporated overlapping sections (overpassing interconnections and repeaters) indicated by the post-incorporating intra-macro floor plan data 14. As a result, (M₁+M₂+. . . +M_{N}) kinds of intra-macro final data 16 are generated from the N kinds of the intra-macro layout data 15 (Step S6). The generated intra-macro final data 16 are stored in the storage unit.

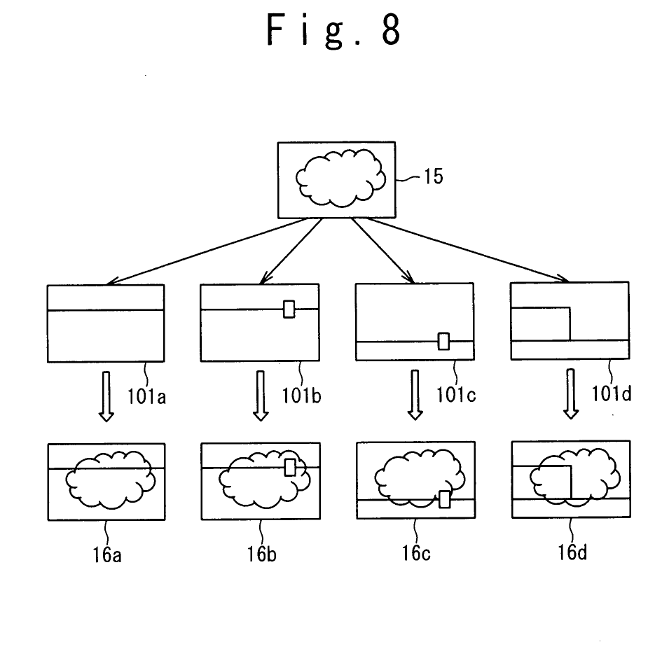

FIG. 8 is a schematic diagram showing a generation of the intra-macro final layout data 16. The intra-macro layout data 15 from which the information regarding the forbidden area is removed is given as shown in FIG. 8. For example, the intra-macro layout data 15 shown in FIG. 8 corresponds to the first macros 101a to 101d of the same kind. Also, the above-mentioned four post-incorporating intra-macro floor plan data 14 (see FIG. 6) associated with the first macros 101a to 101d are given. The intra-macro layout data 15 is merged with each of the four post-incorporating intra-macro floor plan data 14. As a result, four intra-macro final layout data 16a to 16d corresponding to respective of the hierarchy macros 101a to 101d are obtained.

Then, the computer merges the post-incorporating top hierarchy floor plan data 13 generated at the step S2 and the intra-macro final data 16, and planarizes the hierarchical structure. Accordingly, a desired chip data is generated (Step S7). At this time, each hierarchy macro in the intra-macro final data 16 is merged after inverted or rotated so as to coincide with the orientation in the top hierarchy. For example, the intra-macro final data 16a corresponding to the first macro 101a in FIG. 4 is moved in parallel and then merged with the post-incorporating top hierarchy floor plan data 13. The intra-macro final data 16b corresponding to the first macro 101b in FIG. 4 is inverted left-to-right and then merged with the post-incorporating top hierarchy floor plan data 13. As a result, a chip data having the connectivity shown in FIG. 4 is obtained.

According to the conventional designing method, when a plurality of hierarchy macros of the same kind are arranged on the top hierarchy and the positions of the overlapping sections to be incorporated into the respective hierarchy macros are different from each other, the laying-out of the second hierarchy needs to be performed on each of the hierarchy macros. Thus, the number of hierarchy macros requiring the laying-out process is larger than the kinds of the hierarchy macros arranged on the top hierarchy. The operation verification and the layout verification are necessary for each of the hierarchy macros on which the laying-out process is performed. This causes the increase in TAT.

According to the present invention, the positions of the overlapping sections with respect to the hierarchy macros of the same kind are superposed after the orientations of the hierarchy macros are aligned to the same direction, to acquire the forbidden area. Then, the laying-out of the second hierarchy is carried out for each kind of the hierarchy macro with reference to the forbidden area. Therefore, even when a plurality of hierarchy macros of the same kind are arranged on the top hierarchy and the positions of the overlapping sections to be incorporated into the respective hierarchy macros are different from each other, it is enough to execute the laying-out within the macros only one time as for the macros of the same kind. Thus, it is possible to reduce the number of steps for laying-out (designing) a semiconductor device, and hence to reduce the time necessary for the layout process and the TAT in the layout process.

Moreover, according to the present invention, after the layout process in the hierarchy macros, the operation verification and the layout verification are executed for each of the intra-macro layout data 15. The interconnections and components in the verified intra-macro layout data 15 are merged with the incorporated overlapping sections provided from the upper hierarchy, to generate the intra-macro final layout data 16. Thus, it is not necessary to verify each of the intra-macro final layout data 16. Therefore, the TAT in the layout process can be reduced.

According to the present invention, when the N kinds of the hierarchy macros are arranged on the top hierarchy, it is enough to execute the layout design for the N kinds of the hierarchy macros. Thus, the number of the hierarchy macros requiring the layout design and verification is reduced as compared with the conventional technique. Therefore, the TAT can be reduced.

It will be obvious to one skilled in the art that the present invention may be practiced in other embodiments that depart from the above-described specific details. The scope of the present invention, therefore, should be determined by the following claims.

1. A software product for laying-out a semiconductor device by using a hierarchical design method, which is executed by a computer, comprising the functions of:
(A) locating a plurality of macros belonging to a first hierarchy, said plurality of macros including a plurality of first macros having a same function;
(B) arranging a connection structure connecting between said plurality of macros;
(C) extracting from said connection structure a plurality of overlapping sections which overlap with said plurality of first macros, respectively;
(D) incorporating respective of said plurality of overlapping sections into said plurality of first macros, interiors of said plurality of first macros being associated with a second hierarchy lower than said first hierarchy;
(E) calculating a forbidden area associated with any of said plurality of overlapping sections by superposing said plurality of overlapping sections with reference to orientations of respective of said plurality of first macros; and
(F) arranging interconnections and components belonging to said second hierarchy within each of said plurality of first macros such that said interconnections and said components are not provided in said forbidden area.

2. The software product according to claim 1,
wherein said connection structure includes a group of interconnections connecting between said plurality of macros.

3. The software product according to claim 2,
wherein said connection structure further includes a component for adjusting a signal timing which is inserted into said group of interconnections.

4. The software product according to claim 1,
wherein said forbidden area is calculated after said orientations are aligned with each other in said (E) calculating.

5. The software product according to claim 1, further comprising the function of:
(G) generating a layout data by integrating said plurality of macros belonging to said first hierarchy, a non-overlapping section of said connection structure which does not overlap with said plurality of first macros, said plurality of overlapping sections and said interconnections and said components belonging to said second hierarchy.

6. A method of laying-out a semiconductor device based on a hierarchical design method by using a computer, comprising:
(a) locating a plurality of macros belonging to a first hierarchy, said plurality of macros including a plurality of first macros having a same function;
(b) arranging a connection structure connecting between said plurality of macros;
(c) extracting from said connection structure a plurality of overlapping sections which overlap with said plurality of first macros, respectively;
(d) incorporating respective of said plurality of overlapping sections into said plurality of first macros, interiors of said plurality of first macros being associated with a second hierarchy lower than said first hierarchy;
(e) calculating a forbidden area associated with any of said plurality of overlapping sections by superposing said plurality of overlapping sections with reference to orientations of respective of said plurality of first macros;
(f) arranging interconnections and components belonging to said second hierarchy within each of said plurality of first macros such that said interconnections and said components are not provided in said forbidden area; and
(g) generating a layout data by integrating said plurality of macros belonging to said first hierarchy, a non-overlapping section of said connection structure which does not overlap with said plurality of first macros, said plurality of overlapping sections and said interconnections and said components belonging to said second hierarchy, and storing said layout data in a storage unit.

7. The method according to claim 6,
wherein said connection structure includes a group of interconnections connecting between said plurality of macros.

8. The method according to claim 7,
wherein said connection structure further includes a component for adjusting a signal timing which is inserted into said group of interconnections.

9. The method according to claim 6,
wherein said forbidden area is calculated after said orientations are aligned with each other in said (e) calculating.
